(19) United States
(12) Patent Application Publication
(10) Pub. No.: US 2007/0234700 A1
(43) Pub. Date: Oct. 11, 2007

(54) Cleaning apparatus

(76) Inventor: Lance A. Reyniers, Milwaukee, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/393,192

(22) Filed: Mar. 30, 2006

(51) Int. Cl. A01D 7/00

(52) U.S. Cl. 56/400.01

(57) ABSTRACT

A portable cleaning apparatus for removing debris from a fluid retaining enclosure. The apparatus comprises a curved palm portion having a first end and a second end, a plurality of elongated, individual members having an arcuate second end of the elongated member and coupled to the second end of the palm portion at a first end of the elongated member; and an extension fastener coupled to the first end of the palm portion and adapted to permit a manipulator to be coupled to the palm portion.

### FIELD OF THE INVENTION

The present invention relates to an apparatus for collecting waste and cleaning water retained within an enclosure, such as a pond.

### BACKGROUND

Some enclosures retain water and are maintained for productive, recreational, decorative or aesthetic purposes. Some enclosures, such as decorative fish ponds, may require cleaning to remove sediment, waste or debris from the enclosure.

### SUMMARY

In one embodiment, the invention provides a portable cleaning apparatus for removing debris from a fluid retaining enclosure. The apparatus comprises a curved palm portion having a first end and a second end and a plurality of elongated, individual members having an arcuate second end of the elongated member and coupled to the second end of the palm portion at a first end of the elongated member. The apparatus further comprises an extension fastener coupled to the first end of the palm portion and adapted to permit a manipulator to be coupled to the palm portion.

Other aspects of the invention will become apparent by consideration of the detailed description and accompanying drawings.

### BRIEF DESCRIPTION OF THE DRAWINGS

FIG. 1 is perspective view of a cleaning apparatus for cleaning an enclosure retaining water.

FIG. 2 is a perspective view of the cleaning apparatus of FIG. 1.

FIG. 3 is a top perspective view of the cleaning apparatus of FIG. 1.

FIG. 4 is a bottom perspective view of the cleaning apparatus of FIG. 1.

FIG. 5 is a rear perspective view of the cleaning apparatus of FIG. 1.

FIG. 6 is a side perspective view of the cleaning apparatus of FIG. 1.

FIG. 7 is a cross-sectional view of the cleaning apparatus of FIG. 1 taken along line 7-7.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

Although references may be made below to directions, such as left, right, up, down, top, bottom, front, rear, back, etc., in describing the drawings, these references are made relative to the drawings (as normally viewed) for convenience. These directions are not intended to be taken literally or limit the present invention in any form.

### DETAILED DESCRIPTION

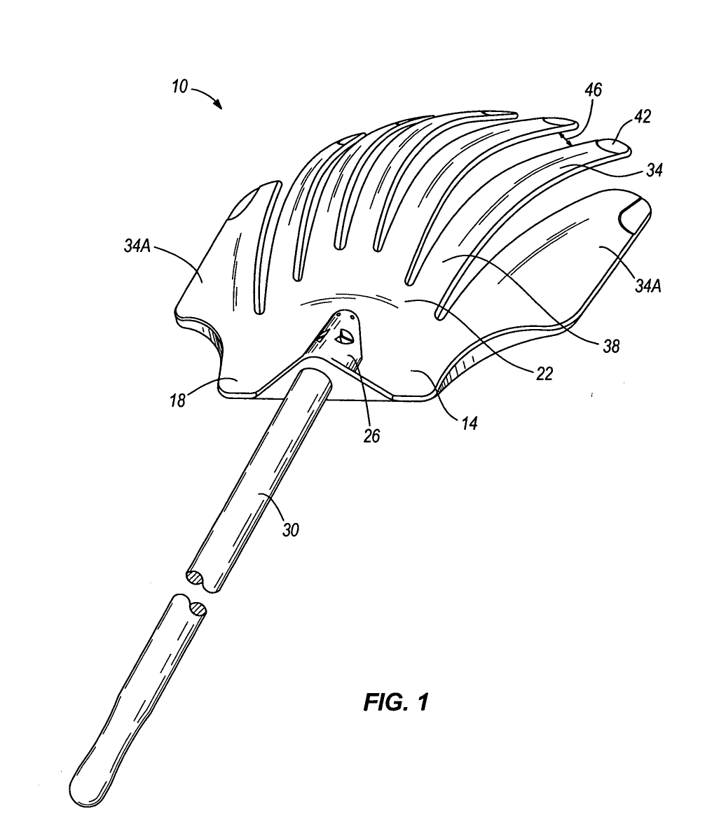

FIG. 1 illustrates a cleaning apparatus 10 for cleaning a fluid enclosure and removing particles from the fluid retained within the enclosure. The enclosure may include a pond, aquarium, pool, spa, fountain or other similar structure that retains a fluid. Such enclosures generally retain fluids such as water.

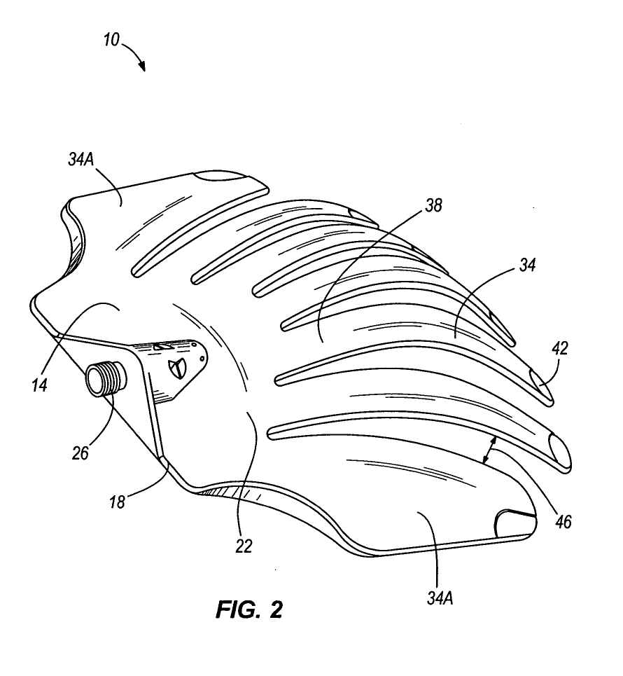

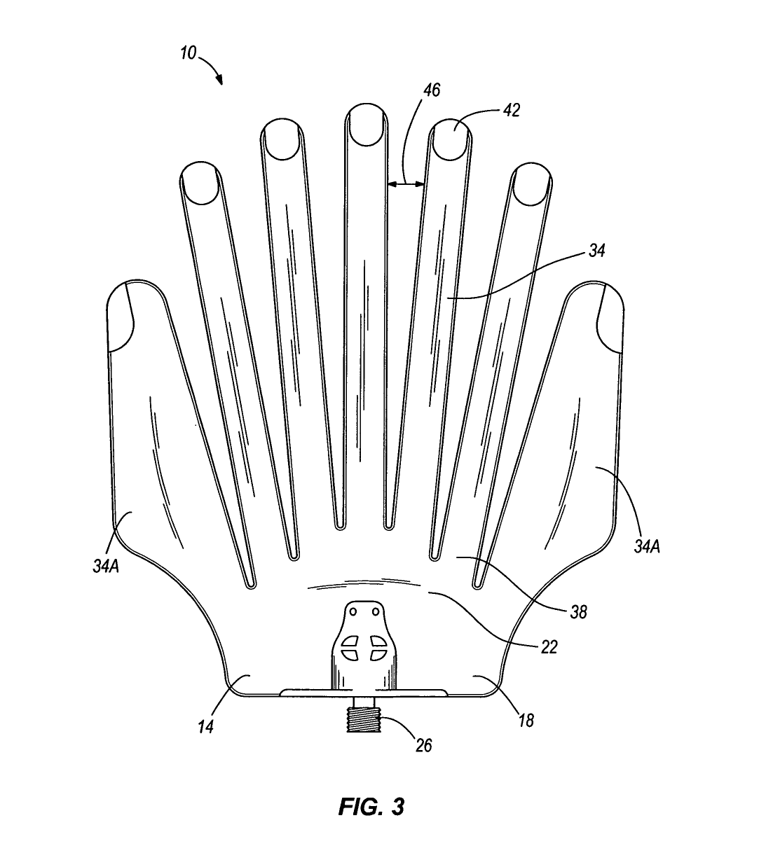

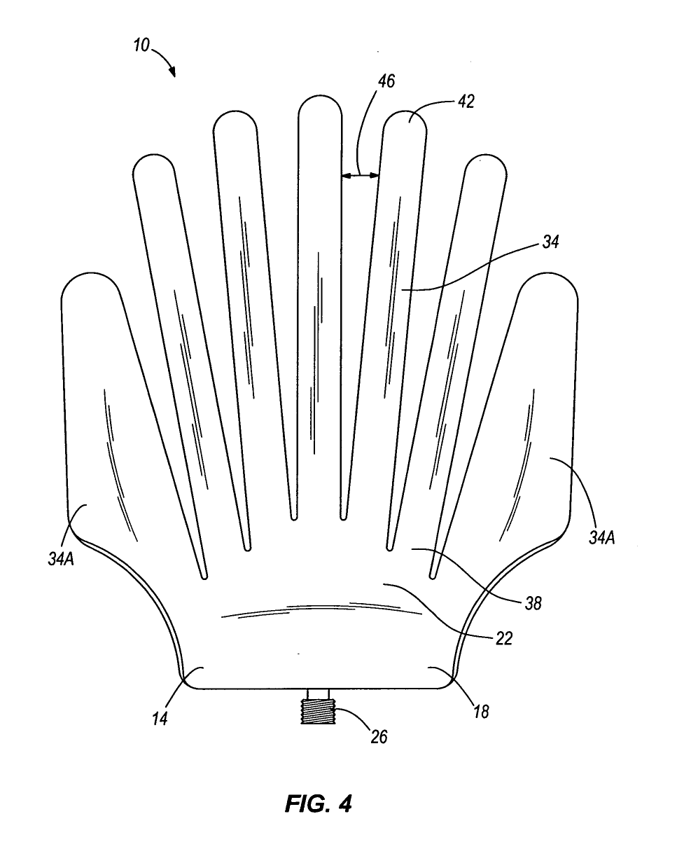

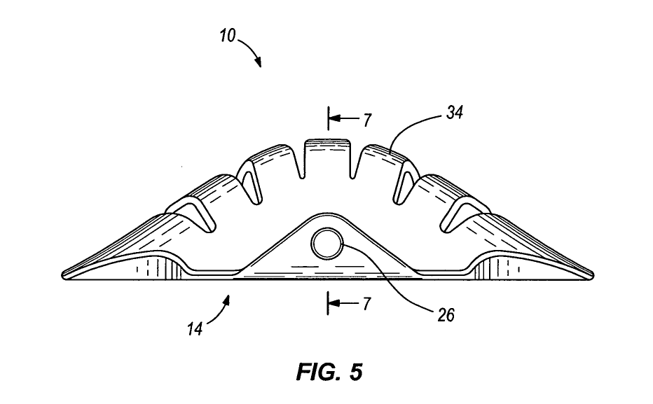

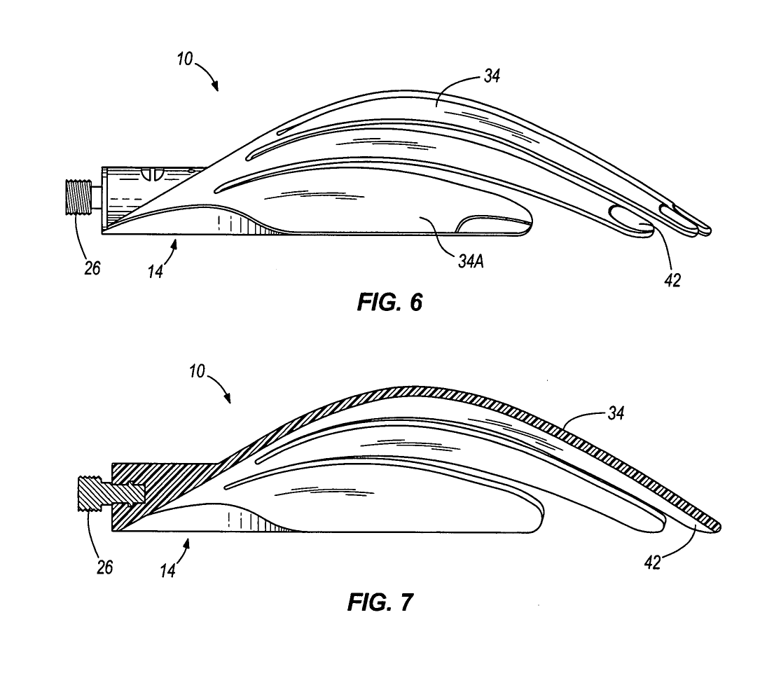

As shown in FIGS. 1-7, the cleaning apparatus 10 is shaped like a hand and configured to be used first as a rake and then as a scoop. The cleaning apparatus 10 has a curved palm portion 14 having a first end 18 and a second end 22. An extension fastener 26 is coupled to the first end 18 of the palm portion 14 and configured to permit a manipulator 30 to be connected to the cleaning apparatus 10. The manipulator 30 may include a pole, a rod, a user's arm or similar type element to extend the length of the cleaning apparatus 10. The manipulator 30 may generally be a rigid construction to permit raking or scooping motion within the fluid enclosure.

A plurality of elongated, individual members 34 are coupled to the second end 22 of the paln portion 14. The elongated members 34 have a first end 38 and a second end 42. The first end 38 of the elongated members 34 are coupled to the palm portion 14. The second end 42 of the elongated members 34 is arcuate and configured to permit smooth motion within the fluid enclosure. The elongated members 34 are separated by spaces 46 and adapted to retain their own independent motion.

In the illustrated construction, the elongated members 34 of the cleaning apparatus 10 are of varying widths. The two outermost elongated members 34A are generally wider than the inner elongated members 34. However, in other embodiments, the elongated members 34, 34A may be of uniform width. In the illustrated construction, the elongated members 34 of the cleaning apparatus 10 are generally flat and have a uniform thickness. However, in other embodiments, the elongated members 34 of the cleaning apparatus 10 are of varying thickness.

In the illustrated construction, the cleaning apparatus 10 may be solidly formed from a molded material, including, but not limited to, polyvinylchloride and EVBS plastic. In some constructions, the cleaning apparatus 10 may be solidly formed by other similar means and from other similar materials, such as rubber or wood.

In operation, the cleaning apparatus 10 can be used in a fluid retaining enclosure for collecting waste and debris collected within the fluid retaining enclosure. The cleaning apparatus 10 is configured for use in a raking motion along the bottom of the fluid retaining enclosure. The arcuate end of the elongated members 34 is configured for smooth motion of the cleaning apparatus 10 and to prevent puncturing of any rubber bladder or membrane which may line the inner surface of such a fluid retaining enclosure. The flexibility of the elongated members 34 also allows the cleaning apparatus 10 to remain in contact with the bottom surface of the enclosure and to be functional following encounters of the cleaning apparatus 10 with hard rigid objects in the fluid retaining enclosure, such as stones, rocks and like debris.

Various features and advantages of the invention are set forth in the following claims.

1. A portable pond cleaning apparatus for removing debris from a fluid retaining enclosure, the apparatus comprising:
a curved palm portion shaped like a hand and having a first end and a second end;
a plurality of elongated, individual members having an arcuate second end of the elongated member and coupled to the second end of the palm portion at a first end of the elongated member, wherein the members are spaced to allow large debris to be retained by the apparatus, wherein at least one of the members is of varying width from one of an other member, wherein the elongated members have the flexibility to be functional to remove debris and to remain in contact with the bottom of the fluid retaining enclosure following encounters of the elongated members with rigid obiects supported by the bottom of the fluid retaining enclosure, and wherein the members are flat and have a uniform thickness; and
an extension fastener coupled to the first end of the palm portion and adapted to permit a manipulator to be coupled to the palm portion, and
wherein the apparatus is comprised of a molded material.

2. (canceled)

3. (canceled)

4. (canceled)

5. (canceled)

6. The apparatus of claim 1, wherein the manipulator is an elongated member coupled to the extension fastener.
